(19) United States
(12) Patent Application Publication
(10) Pub. No.: US 2019/0080128 A1
(43) Pub. Date: Mar. 14, 2019

(54) System And Method For Tracking Consumable Items

(71) Applicant: Fresh Press LLC, San Francisco, CA (US)

(72) Inventors: Douglas Evans, Brooklyn, NY (US); Paul Katz, San Marino, CA (US); Nelson Apollo Lee, Campbell, CA (US)

(21) Appl. No.: 16/123,972

(22) Filed: Sep. 6, 2018

Related U.S. Application Data
(60) Provisional application No. 62/557,397, filed on Sep. 12, 2017.

(51) Int. Cl. G06K 7/14; G06K 19/06; G06Q 20/20

(52) U.S. Cl. CPC G06K 7/1417; G06Q 20/20; G06K 19/06037

(57) ABSTRACT

A distributed system uniquely tracks individual consumable items within a stream of commerce and tracks ingredients used in consumable items. The distributed system further provided tracks the sale of the consumable items to the consumer. A point-of-consumption system (e.g., juicer) is used to allow consumer access to the consumable item and the distributed system controls the point-of-consumption system to control access to the consumable item, including blocking use or providing an alert when a consumable item should not be consumed due to recall, expiry, allergy, or other reason.

### RELATED APPLICATIONS

This application claims the benefit of U.S. Provisional Application Ser. No. 62/557,397 filed Sep. 12, 2017 and entitled SYSTEM AND METHOD FOR TRACKING CONSUMABLE ITEMS, which is hereby incorporated herein by reference in its entirety.

### BACKGROUND

### Field of the Invention

Embodiments disclosed herein are related to the sale and tracking of consumable items.

### Background of the Invention

Generally, consumable items such as food, produce, and the like are placed into the stream of commerce by distributors, and they make their way to consumers where they are consumed and/or destroyed. When recalls of certain items occur, it is difficult to determine the impact of such release of items on the public. Many resources, both in time and money, are used to remove recalled items from the stream of commerce.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a block diagram depicting a distributed system of one embodiment;

FIG. 2 is a flow chart depicting typical stream of commerce processes with consumable items;

FIG. 3 is a flow chart depicting improved processes for tracking consumable items according to some embodiments;

FIG. 4 is a flow chart depicting computer-based tracking of consumable items according to some embodiments;

FIG. 5 is an example point-of-consumption system according to some embodiments;

FIG. 6 is an example database according to some embodiments;

FIG. 7 shows various communication sequences according to some embodiments;

FIG. 8 is a front view of a juicer system according to some embodiments;

FIG. 9 is a portion of a front view of a juicer system according to some embodiments; and

FIG. 10 is a computing device suitable for implementing methods in accordance with embodiments of the present invention.

### DETAILED DESCRIPTION

In one embodiment, a distributed system is provided that permits tracking of individual consumable items within a stream of commerce. For instance, food items that may be recalled are typically tracked by a lot number, source information, or other identifying information. Such tracking information is generally collected manually to determine what manufacturers and distributors are affected, and once known, general messages are sent to the public (e.g., via Internet, radio, news, television, etc.) to warn the public of potential issues. However, it is appreciated that consumers may not receive notice in a timely manner prior to consuming the product, and this delay potentially creates health and safety issues. Further, from a manufacturer or other provider prospective, there is no way to determine which consumers were affected, or how to contact them in a timely manner. As records are generally kept differently between providers, distributors, and other links in the stream of commerce, and there is no standard way of tracing consumable items in a consistent way.

According to one aspect, a system is provided that permits tracking of consumable items to the consumer. The system includes methods for uniquely identifying consumable items, along with their constituent ingredients, so that they may tracked through the stream of commerce. Further, a distributed system is provided that tracks the sale of the consumable items to the consumer, and includes contact information for the consumer so that entities such as a distributor, manufacturer or other provider can reach consumers in a timely manner.

Further, in some embodiments, a point-of-consumption system is used to allow consumer access to the consumable item, and a distributed system for controlling access to the consumable item is provided that could avert a safety issue. In some embodiments, the point-of-consumption system may receive (e.g., over a communication network) a list of consumable items that should not be consumed, for example, because of recalled ingredients, recalled food items, faulty manufacture, or other reasons. In this way, the point-of-consumption system can be updated prior to an access of a consumable item that could cause a safety issue. Further, the point-of-consumption system may be capable of identifying individual consumable items, and may be capable of recording access to certain consumable items for tracking and alerting purposes. Also, the distributed system may correlate the point-of-consumption system with a particular consumer for the purpose of performing various functions described herein.

Further, in some embodiments, the system includes a point-of-sale system adapted to conduct a transaction with one or more consumable items and a database coupled to the point-of-sale system over a communication network. The database is adapted to map the transaction with the one or more consumable items to an identifier of a consumer.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

It should be understood that aspects are described herein with reference to certain illustrative embodiments and the figures. The illustrative embodiments described herein are not necessarily intended to show all aspects, but rather are used to describe a few illustrative embodiments. Thus, aspects are not intended to be construed narrowly in view of the illustrative embodiments. In addition, it should be understood that certain features disclosed herein might be used alone or in any suitable combination with other features.

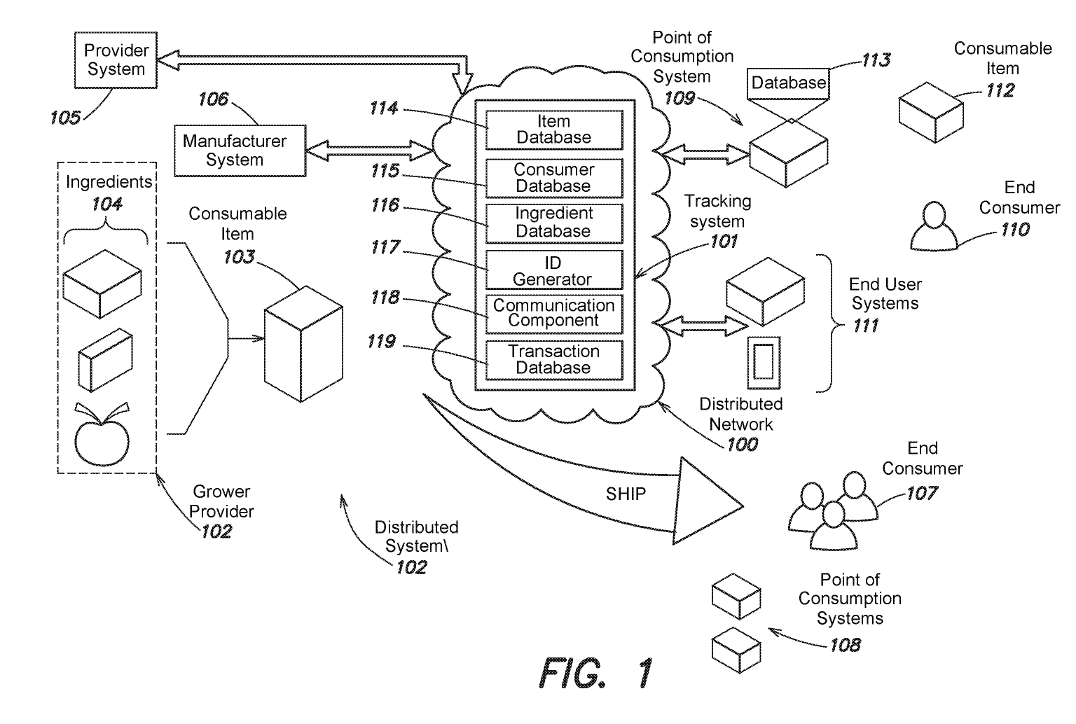

FIG. 1 is a block diagram depicting a distributed system according to various embodiments described herein. As discussed above, a distributed system may be provided that permits tracking of consumable items. Consumable items might be for example, goods such as food or other types of items that have a finite usable life and are generally consumed by end consumers. Generally, because items of this type are numerous and are constantly being created and used, it becomes unwieldy to track such items. To this end, a distributed system 120 may be provided that permits providers, manufacturers, and other entities to adequately track consumable items as they travel through the stream of commerce, and provides additional functionalities when there are issues with the consumable items themselves (e.g., a recall) or any of their ingredients.

System 120 may include, for example, a number of computer systems coupled through one or more communication networks including distributed network 100. A tracking system 101 may be provided that is capable of tracking consumable items in their constituent ingredients from their sources to endpoints of consumption by one or more end consumers (e.g. end consumers 107).

A grower/provider 102 may produce one or more ingredients 104 or other elements that may be used to constitute a particular consumable item (e.g., consumable item 103). Such items are purchased and shipped to various consumers (e.g., in consumers 107). In other various embodiments, the distributed system includes one or more point-of-consumption systems (e.g., point-of-consumption systems 108) that are used by consumers to access a particular consumable item. For example, in some embodiments, the point-of-consumption systems include juicers that are capable of producing juice for a consumer from consumable items such as juice packs that are purchased and delivered to the consumer and pressed by the juicer

It should be appreciated that the inventors have invented a system and method to track distribution and consumption of a physical product. Though aspects are discussed herein with reference to a tracking distribution and consumption of juice packs, the present invention is not so limited and the system and methods described herein can be employed with any beverage system or any other product or consumable. It should also be noted that such a consumable item is not strictly limited to an ingestible product but instead can be any other product that is effectively spent after use or where the product use is to be limited, such as at certain geographic locations, certain time restrictions or a fixed number of uses.

Tracking system 101 may include one or more components used to manage consumable items. In particular, system 101 may include an item database 114 that stores information relating to one or more consumable items. Further, system 101 may include a consumer database 115 that includes information relating to a consumer such as, for example, a consumer identifier, contact information (e.g., email address), and possibly information relating to any point-of-consumption systems that may be used by the consumer. Further, system 101 may include an ingredient database 116 that identifies different ingredients that may be used within the consumable items, identifies growers or other providers (e.g., provider 102) or any other information relating to the ingredients (e.g., lot number, batch number, production location, etc.).

System 101 may also include an ID generator 117 which is capable of generating unique IDs for each consumable item that is produced. For instance, according to some embodiments, a unique ID created for each and every consumable item that is produced. Such information may be used to index into other databases, so as to locate ingredients, consumers, point-of-consumption systems and/or any other information that relates to a particular consumable item.

Further, tracking system 101 may include a communication component 118 that is adapted to communicate messages, alerts, or other status information between one or more systems. For instance, communication component 118 may be capable of communicating with a provider system 105, a manufacturer system 106, a point-of-consumption system 109, one or more end user systems 111, or any other entity or system. Further, system 101 may include a transaction database 119 that includes information relating to any purchase transactions relating to any of the identified consumable items. Notably, the transaction database may include a mapping of particular consumable items to particular end consumers.

System 101 may be implemented on, for example, a distributed network 100 which comprises one or more physical and/or virtual systems, databases, and processing entities. Further, system 101 may include one or more user interfaces for facilitating transactions, searching databases, producing reports, or other functions. In one embodiment, the system may be implemented within a cloud-based using one or more well-known systems (e.g., Amazon EC2).

In a typical transaction, an end consumer 110 may purchase a consumable item 112 using one or more end user systems 111 (e.g., a cell phone). The consumable item may be shipped to the end consumer 110 and received at some later point. If there is a particular issue with the consumable item 112 or any of its ingredients, tracking system 101 may be capable of identifying and tracing the issue to the receiving end consumer 110 and directly alerting the end consumer for the purpose of minimizing risk and possibly averting injury to the end consumer 110.

Further, if the end consumer uses a point-of-consumption system 109 to access the consumable item, system 101 may communicate information to the point-of-consumption system 109 for the similar purpose of minimizing risk and possibly averting injury to the end consumer 110. To this end, the point-of-consumption system 109 may include one or more databases (e.g., database 113) that stores identifiers of consumable items that should not be used by the consumer. Similarly, if the point-of-consumption system 109 is connectable to a network, system 109 may retrieve an identifier of a consumable item to be rendered, and check whether the consumable item should be processed by one or more online databases associated with system 101.

In another situation, where an issue may be identified after a consumable item has been consumed, usage information collected by the point-of-consumption system 109 may be communicated back to the tracking system 101 for the purpose of identifying which consumable items have been consumed (and possibly pose a risk to an end consumer). Similar to the situation described above, the end consumer (e.g., consumer 110) can be notified that they used and/or ingested a faulty consumable item.

It should be appreciated that although certain implementations are discussed herein by way of example that one or more functional elements can be implemented on one or more systems, one or more databases may be separate or combined, or otherwise located on one or more systems, and that the invention is not limited thereto unless explicitly claimed.

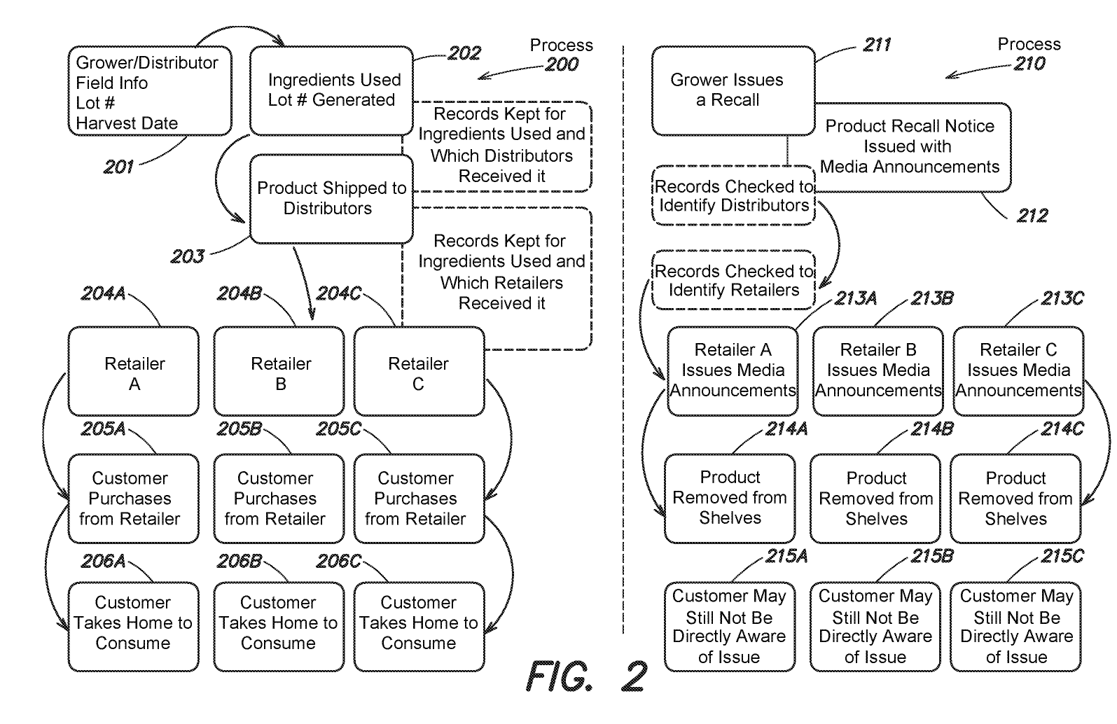

As discussed, there are many conventional ways of tracking consumable items such as food as they make their way through the stream of commerce. FIG. 2 is a flow chart depicting typical stream of commerce processes with consumable items. According to various aspects, it is appreciated that conventional processes are insufficient, and result in delay in identifying consumers when issues occur with consumable items. In particular, as shown in FIG. 2, a process 200 shows a typical method for distributing consumable items into a stream of commerce.

At block 201, a grower/distributor produces ingredients that may be used within a particular consumable item. Such ingredients may include identifying information such as field information, lot number, grower identification, harvest state or any other source information. At block 202, ingredients are used to make a consumable item and lot numbers are generated. Records are kept for particular ingredients used, and which distributors may have received the consumable items. At block 203, the product is shipped to distributors. From there, distributors may provide the consumable items to one or more retailers (e.g., retailers A-C (elements 204A-204C)). Records may be kept which identified what ingredients were used in which retailers may have received the products. Customers may then purchase one or more of the consumable items from the retailers (e.g., at blocks 205A-205C), after which the customers take the purchased items to their home to consume (e.g., at blocks 206A-206C). Notably, there are generally no records kept regarding who purchases which particular items.

Process 210 shows a typical method for sending recall information regarding particular items. At block 211, a grower issues a recall. A block 212, a product recall notice is issued, generally distributed via media announcements (e.g., Internet, radio, television, etc.). In the meantime, the grower may check their records to identify particular distributors that may have distributed the faulty product. In turn, the distributors may check their records to identify particular retailers that may have received the product. It is appreciated that many of these checks are not automated, and therefore result in delay in identifying particular streams that may be affected

Once retailers are identified, various retailers may issue media announcements (e.g., at blocks 213A-213C) to contact customers. In the meantime, retailers may remove the product from their shelves (e.g., at blocks 214A-214C) so that customers may not purchase any defective items. Notably, it is appreciated that customers may still not be directly aware of issue because they may not have received messages through the media or have otherwise heard of the issue through other people. Because there is no tracking capability to an end customer, such people may consume products being unaware of the recall. Also, if consumed, there is no messaging to the end customer that the consumed item may be at fault.

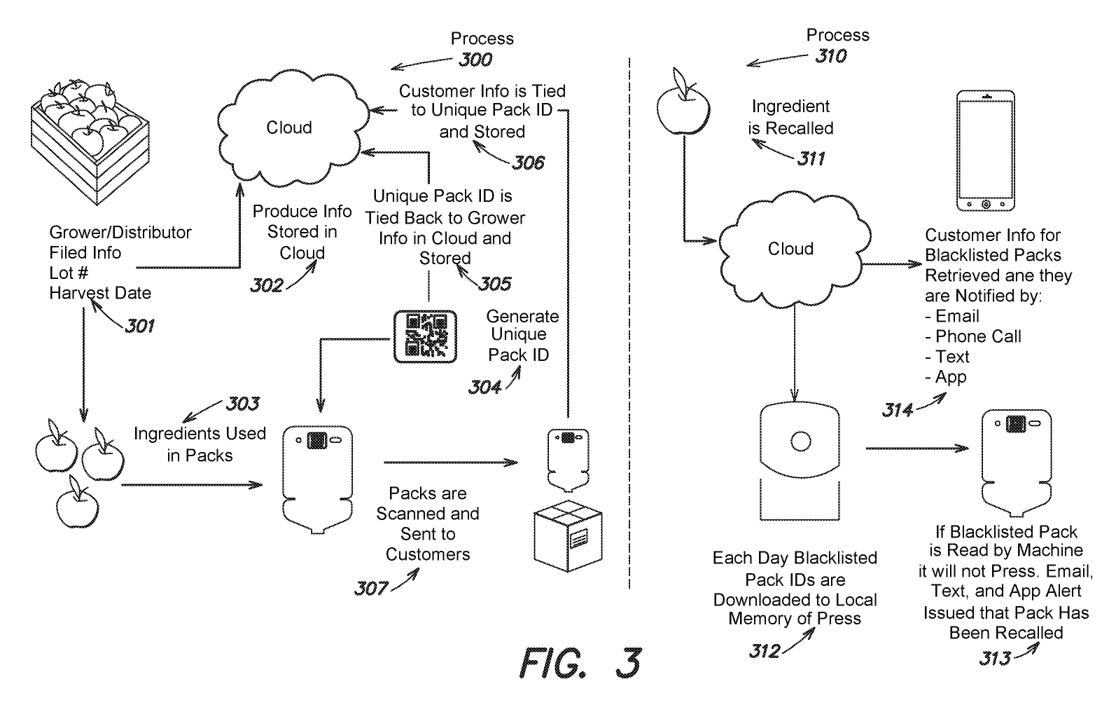

Because of these drawbacks, it may be beneficial to have a system that is capable of alerting customers and restricting access to consumable items when issues arise. FIG. 3 is a flow chart depicting improved processes 300, 310 for tracking, alerting, and restricting access to consumable items according to some embodiments.

In particular, in process 300 at 301, a grower/distributor provides information regarding one or more ingredients, such as for example, lot number, harvest date, grower information, among other types of information. At 302, information relating to the ingredients (e.g., produce information) is stored within a distributed computing system (e.g., a cloud-based system such as tracking system 101). At 303, ingredients provided by the grower are used to produce the consumable items (e.g., ingredients are included within juice packs). At 304, a system is used to generate a unique consumable product identifier (e.g., a unique juice pack identifier) which is then placed or written on some portion of the consumable item. The consumable items may be scanned by system and then sent to particular customers at 307. Also, according to some embodiments, juice packs ordered by customers online may be associated with unique pack identifiers and stored (e.g., in a cloud-based computing system such as tracking system 101) at 306. Notably, a system such as tracking system 101 is capable of associating ingredients to particular consumable items which are then shipped to identify customers. In this way, constituent elements of the consumable item may be tracked to particular customers.

Process 310 shows an example recall method that may be used according to various embodiments. At 311, a particular ingredient is recalled. Rather than pursuing manual processes of determining chains of distribution or accessing various media outlets to notify customers, customers are directly identified and contacted, and according to various embodiments, point-of-consumption systems may be communicated with two prevent dispensing of faulty consumable items. For instance, at 314, customer information for defective juice packs are retrieved and customers may be notified via one or more communication channels such as, for example, email, phone call, text messages, or notifications within applications (e.g., a phone application relating to a particular juicer device).

Further, at 312, identifiers associated with particular defective consumable items may be downloaded to one or more point-of-consumption systems. For instance, each day, blacklisted pack IDs may be downloaded to a local memory of a juice press system. At 313, if a blacklisted pack is read by the machine, the machine may compare the unique identifier associated with the pack in question with the list of blacklisted pack IDs. The juice press system may be adapted to restrict or prevent dispensing of the juice pack to the consumer responsive to determining that the juice pack in question is among those of the blacklisted packs. In an alternative configuration, a juice press system may contact one or more systems to determine whether a pack in question is capable of being dispensed (e.g., without having a list of approved or faulty packs within local memory). It is appreciated that because many steps are bypassed or eliminated, the chance of consuming a faulty juice pack is reduced. Further, it should be appreciated that faulty packs that are read by particular machines may be identified to tracking system 1012 perform other actions, such as for example, reordering or delivering replacement juice packs, compiling lists of consumers that received faulty juice packs, among other actions.

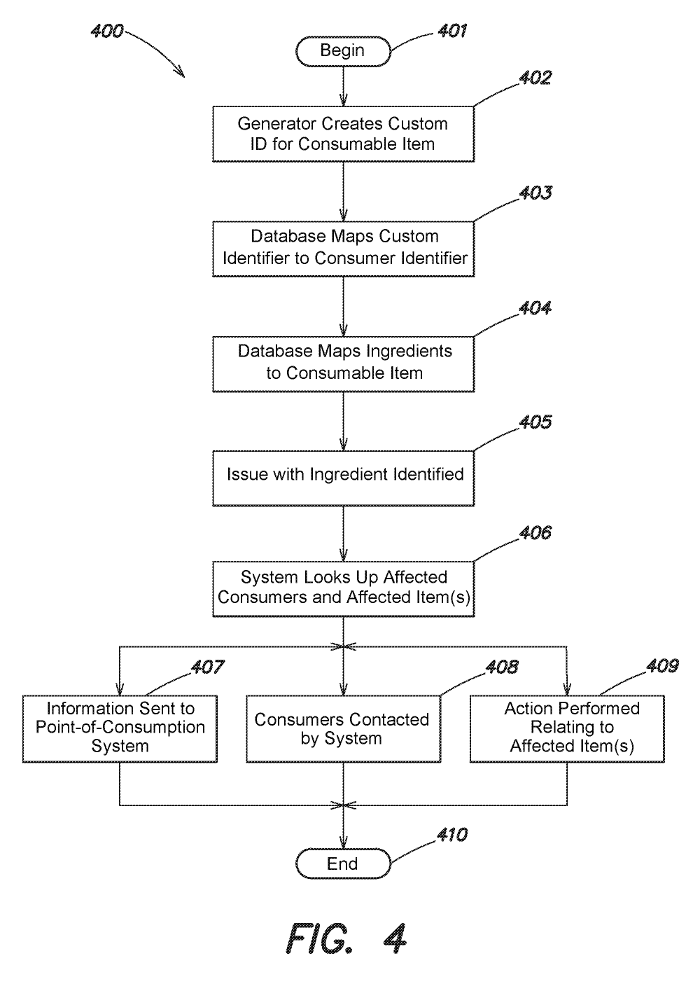

FIG. 4 is a flow chart depicting computer-based tracking of consumable items according to some embodiments. In particular, FIG. 4 shows a process 400 for tracking consumable items within a computer system according to various embodiments. At block 401, process 400 begins. At block 402, the system (e.g., tracking system 101) generates a custom identifier (e.g., a juice pack ID) for consumable item (e.g., a juice pack). At block 403, a database associated with the system maps a custom identifier to a consumer identifier indicating which consumer received the consumable item. Further, the consumer identifier may have other information associated with it including contact information for particular consumers. At block 404, the database also maps ingredients to a particular consumable item identified with the unique custom identifier (e.g., a particular ID of a particular juice pack).

At some point later after production of the consumable item, an issue may be found with the consumable item or one or more ingredients (e.g., at block 405). A block 406, the system may look up (e.g., within the database of the system) affected consumers and any affected items. The system may perform one or more actions, such as, information may be sent to one or more point-of-consumption systems at block 407, such as a list of affected items and their unique identifiers. Further, at block 408 consumers may be directly contacted by the system such as through email, app notifications, text messages or other contact methods. Such contact may be performed automatically as the system may have access to a database including their contact information. At block 409, any other action may be performed relating to the affected items such as performing a reorder process and shipment of replacement items, or any other action necessary. At block 410, process 400 ends.

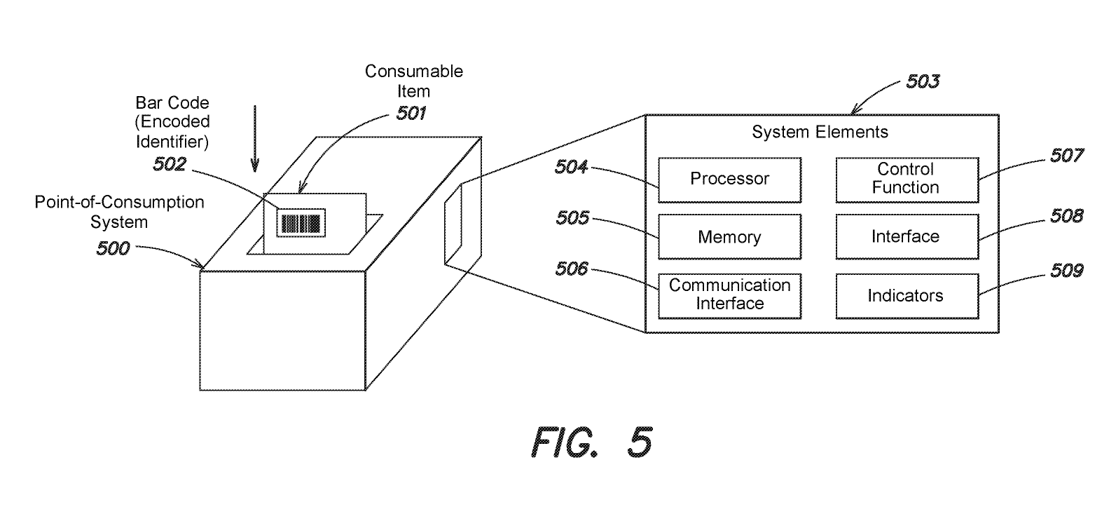

FIG. 5 is an example point-of-consumption system 500 according to some embodiments. In particular, the point-of-consumption system 500 is configured to receive one or more consumable items (e.g., consumable item 501) and provide access to a consumer to that particular consumable item. According to some embodiments, each consumable item may include one or more identifiers including a barcode 502 which includes an encoded unique identifier of the particular consumable item, such as a juice pack. System 500 may include one or more system elements 503 which are used to control system functions, communicate with other systems, and allow the consumer to operate the point-of-consumption system. For example, system elements 503 may include a processor 504, a memory 505, and one or more interconnections mechanisms (e.g., buses, switches or the like) that are capable of executing a program that operates the system. Such a system 500 may include one or more embedded systems, processors or components that may receive a special purpose program for controlling such a system 500.

System 500 may also include other elements such as, for example, a communication interface 506 which may be, for example a Wi-Fi, Bluetooth or other type of interface that permits system 500 to communicate over one or more communication networks. Notably, point-of-consumption system 500 is capable of communicating with tracking system 101 for the purpose of controlling access to one or more consumable items. For instance, one of consumption system 500 may include a controls function 507 that is capable of permitting or denying access to one or more consumable items (e.g., consumable item 501). System 500 may also include one or more interfaces (e.g., interface 508), indicators (e.g., indicators 509), or other elements that permit the consumer to interact with system 500. System 500 may also be capable of communicating and/or operating with one or more other systems such as a cell phone, applications, or other systems for the purpose of communicating with the consumer and/or performing control functions, ordering consumable items, or providing one or more indications to the consumer.

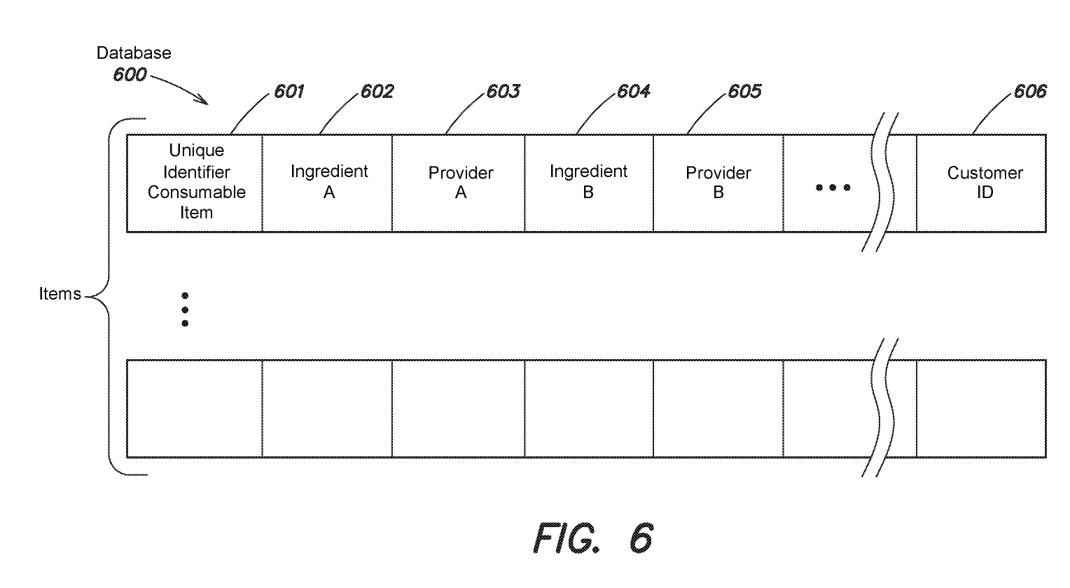

As discussed above, tracking system 101 may include one or more databases to track items, providers, ingredients, and customers. FIG. 6 is an example database according to some embodiments that may be used for tracking items. In particular, database 600 may include one or more databases, lists, tables, or other items for associating unique identifiers of consumable items with their ingredients, their providers, and the customers that purchase them. For example, a particular database 600 may include as a standard element a unique identifier for each consumable item (element 601). Associated with that item may be one or more ingredients such as ingredient A (element 602), provider A (element 603), ingredient B (element 604), provider B, among other elements and providers. Also associated with that item may be a customer ID that identifies a customer that purchased and/or received the item. It should be appreciated that database 600 may include information regarding the customer such as contact info, numerous methods for contacting the customer (e.g., phone information, email addresses, or other contact information) stored within the database. Tracking system 101 may be capable of providing one or more search interfaces for locating particular consumers, performing automated actions in response to defective ingredients or items, automatic communications between system 101 and one or more point-of-consumption systems, among other functions or actions.

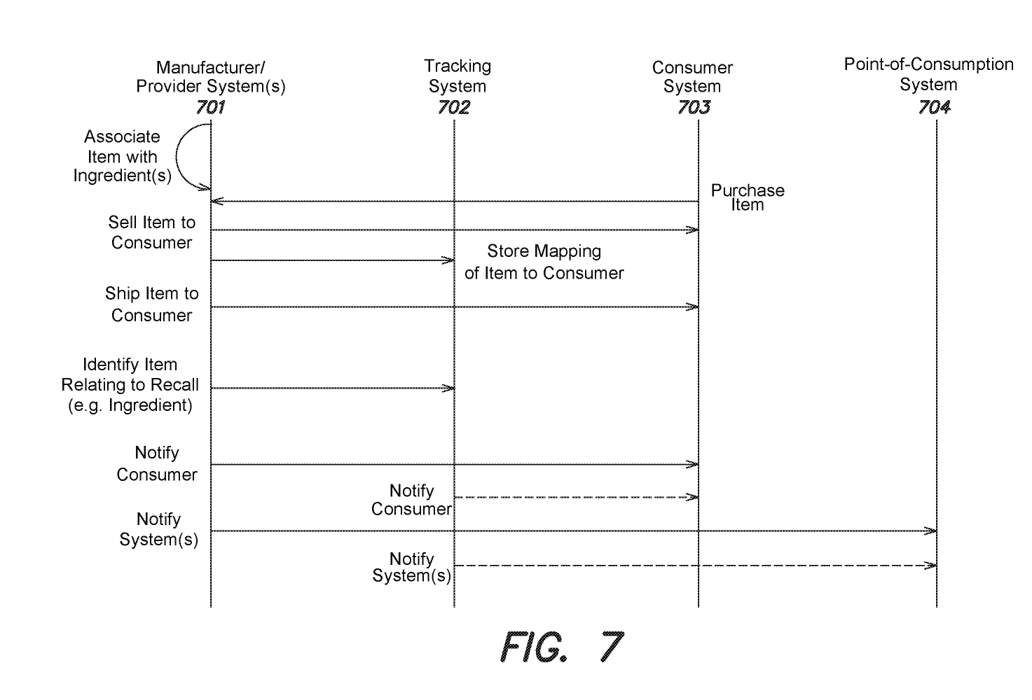

As discussed above, many computer-based systems may be involved in practicing various embodiments. For instance, FIG. 7 shows various communication sequences between computer systems according to some embodiments, including manufacturer/provider systems 701, tracking system 702, consumer system 703, and point-of-consumption system 704. For example, systems 701 may include one or more computer systems operated by a manufacturer or provider. Tracking system 702 may be, for example, the same or similar to tracking system 101 as shown in FIG. 1. Consumer system 703 may include, for example, a computer, cell phone, tablet or other type of personal computing system associated with a particular consumer. As discussed above, a point-of-consumption system may include a juice press system.

As discussed, the system may associate a particular consumable item with one or more ingredients. Such information may be provided from system 7012 tracking system 702. After production, a consumer system 703 may be used to purchase an item from the manufacturer/provider. In one embodiment, the point of sale system can be implemented on a mobile device, such as a smart phone or tablet, to create a mobile point of sale system. At that point, system 701 and in an alternative implementation, system 702 may store an association of that purchased item with the consumer. Such information mapping ingredients, providers, manufacturers, and consumers may be stored in one or more databases as discussed.

After purchase, the consumable item may be shipped to the consumer. At some point after production an association with the consumer, some item relating to the production of the consumable item may be identified as relating to a recall. For instance, one or more ingredients may be recalled from a grower or other producer. According to one embodiment, a tracking system either alone or in association with other systems may contact the consumer indicating that the particular consumable item is faulty. In some embodiments, the tracking system either alone or in association with other systems (e.g., manufacturer/provider system 701) May notify one or more point-of-consumption systems (e.g., system 704) of the faulty item. This may include, for example, providing a list of faulty items to the point-of-consumption system which can then be stored in a memory and later accessed when consumers attempt to use the consumable item.

Further, the point-of-consumption system to perform one or more functions responsive to identifying a particular consumable item at the location where it is being consumed. For example, the point-of-consumption system may be capable of looking up, based on a unique identifier associated with consumable item, whether that consumable item should be delivered to a consumer/customer. For example, when the consumer tries to access the consumable item, the point of consumption system actively accesses a database (e.g., online or stored within the point-of-consumption system) to determine one or more actions with that consumable item. In one alternative embodiment, the point of consumption system may also be associated with one or more consumers, and may use consumer profile information to determine whether the consumable item should be delivered to the consumer. In one example implementation, the point of consumption system may use user profile information to determine whether or not a consumer is allergic to one or more ingredients within the particular consumable item being rendered to the consumer. In some embodiments, the point-of-consumption system is in communication with a personal device of the user or some other system in order to exchange information relating to a particular consumer. For instance, the point-of-consumption system may communicate using one or more protocols to nearby personal devices for the purpose of communicating information to the consumers using those systems.

It should also be appreciated that the point-of-consumption system may itself initiate one or more actions, messages, indications to other distributed system components, lookups or database operations. Further, the point-of-consumption system may react to one or more inputs, such as for example, alerts received from a tracking system, a manufacturing system, consumer input and/or devices or other components connected through a distributed communication network.

In another example implementation, one or more databases may track one or more intermediate locations, delivery points, retailers, or other suppliers that may be involved in producing and/or delivering the consumable item to the consumer. A point-of-consumption system may have access to such a database to determine one or more actions that can be performed relating to a particular item. For instance, an action can be purely informational, such as displaying to the consumer a chain of delivery of the item to the consumer. In alternative system implementation, the action that is performed by the point-of-consumption system may prohibit access to the item (e.g., a point in the delivery chain experienced a refrigeration point past limits set by a manufacturer).

### Example Juice Machine Implementation

Accordingly, as discussed in the foregoing description, it should be appreciated that the inventors have invented a system and method to control the point of consumption of a physical product. Though aspects are discussed herein with regard to juice press machines and juice packs, the present invention is not so limited and the system and methods described herein can be employed with any beverage system or any other product or consumable. It should also be noted that such a consumable is not strictly limited to an ingestible product but instead can be any other product that is effectively spent after use or where the product use is to be limited, such as at certain geographic locations, certain time restrictions or a fixed number of uses.

In one embodiment, a single serve juice pack is normally purchased by a consumer for use in a juice press. Aspects of such a juice press will be described below, though examples of such juice presses and juice packs are described in the Applicant's PCT publication WO2014/182423 filed April 18, 2014 and Applicant's PCT application PCT/US2017020428 filed Mar. 23, 2017, each of which is hereby incorporated by reference in its entirety. Such juice presses can be provided by the seller for immediate use of the purchased juice pack, or owned by individual consumers for home use.

In one embodiment, each juice pack is associated with a unique digital identifier. When purchased by a retailer or similar entity that desires to distribute the packs for consumption, each juice pack purchased by the retailer is then associated with a virtual token unique to the retailer and stored in a virtual token database (e.g., in a cloud-based system). Such a virtual token database may be part of or separate from the pack database. When a consumer attempts to use the juice pack in a juice press, the juice press checks the pack's identifier (e.g., by scanning an identifier included, by, for example, printed, on the juice pack) and checks if the pack is associated with a specific juice press (e.g., by performing a lookup to the virtual token database). The system compares an identifier of a specific juice press with an entry in the virtual token database to determine if the specific juice pack is permitted to be pressed in the identified juice press. If the juice press and pack are properly associated (e.g., the press was purchased at a retail outlet and the press is associated with the retail outlet), the pack is squeezed as normal. This ensures that where a pack is consumed is controlled by the retailer. If a consumer attempts to use the pack in another juice press not owned or otherwise controlled by the retailer, the juice press does not press the pack, preventing consumption of the juice pack. Thus, according to some embodiments, the system monitors and controls both the point-of-sale and the point-of-consumption of the juice pack.

As is readily appreciated, the described system and methods allows a company to keep track of when a pack is purchased via the app scanning the pack and recording the time of payment. It also allows a company to control where and when the pack is purchased by placing restrictions on when the app can permit a payment. The system and methods described also allow a company to control where packs are consumed. Thus, the system controls and monitors both point-of-sale and point-of-consumption of the packs.

Turning now to the juicers, devices that extract juice from food matter are known in the art. Examples of such juicers are described in detail in the above-mentioned PCT documents and otherwise available from the Applicant. For the system of the present disclosure, the juicer is equipped with reader suitable for scanning the information-containing regions on the packs. For example, a reader may include a camera, an optical scanner, a laser scanner, a magnetic reader, a radio frequency identification (“RFID”) tag reader, or any other suitable reader capable of reading associated information which may be included on an associated juicer pack, as described below. Correspondingly, the information region of the juicer pack may include features to store and recall the desired information, such as printed or digital indicator technologies including, but not limited to, bar codes, quick response (QR) codes, RFID devices, magnetic strips, a color bar or other similar graphics (e.g., printed graphics, embossed graphics and/or etched graphics), a time temperature indicator, and/or any other suitable readable medium.

In some embodiments of the juicer, the reader may be positioned on the juicer such that it may read the information on a pack when the pack is loaded into the pressing chamber of the juicer in a correct orientation. Accordingly, in some embodiments, the juicer may include pack supports and/or orientation features such that the information region on the juicer pack is aligned with the reader on the juicer when the pack is correctly positioned and oriented within the juicer. However, it should be understood that in some embodiments, a reader may not require line-of-sight to read the information region of the pack. In one such embodiment, an RFID reader only needs to be within an appropriate range of an associated RFID tag.

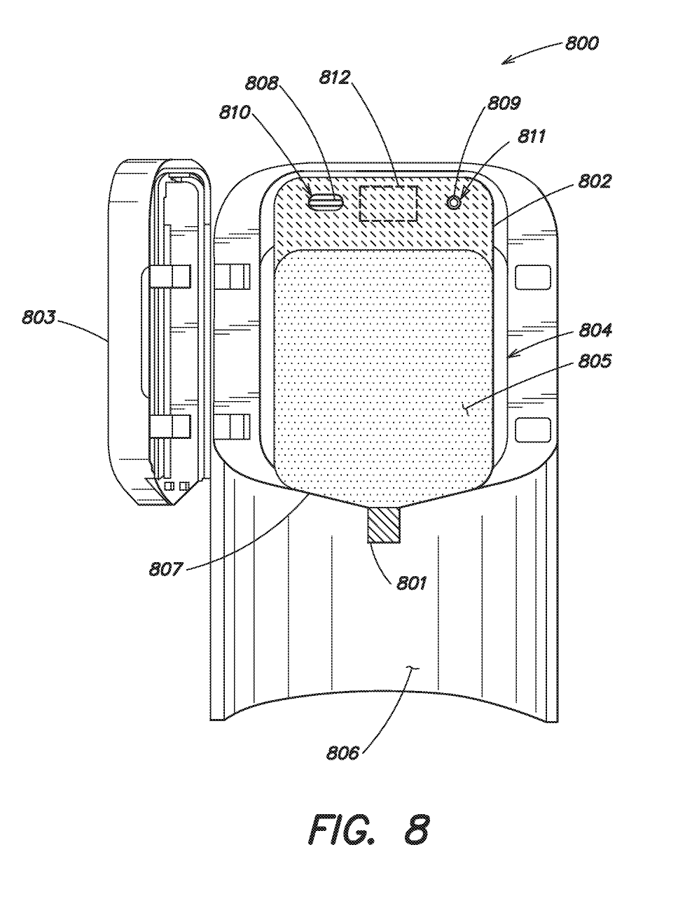

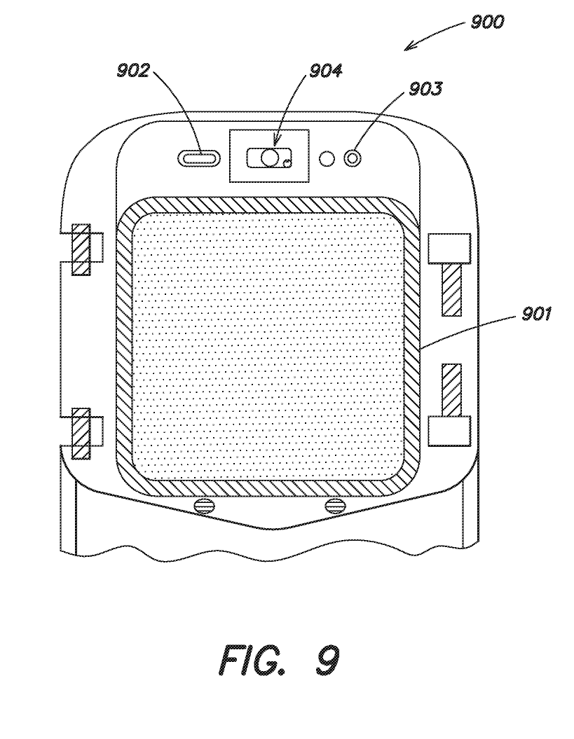

Turning to FIGS. 8 and 9, an embodiment of a juicer 800, 900 (shown in different views) will now be described. The juicer 800 includes a base 806 having an upper pressing region defined by platen 804 and press cover 803. When the pack 805 is placed in the pressing region, the outlet 801 of the pack extends through the outlet 807 of the pressing region. As shown in FIG. 9, the press 900 also includes a reader 904 positioned between pack supports 902 and 903, though other locations are also contemplated. FIG. 8 shows the juicer with a pack 800 in position, where pack 800 includes an information region 812 that is aligned, and in some instances, oriented towards the reader 904 when the pack is appropriately oriented and positioned within the pressing region. For example, in the depicted embodiment, the pack includes an upper portion 802 that includes orientation cutouts 810, 811. Orientation cutouts allow the pack to hang onto supports 808, 809 respectively. Upper pack region also includes information region 812 on one side that may include printed media such as a QR code, or other appropriate information encoding method. As shown in FIG. 8, the information region 812 is disposed on a side of the juicer pack that faces inwardly towards the reader 904 (not shown in FIG. 8 as it is not visible due to the pack covering the reader) when the juice pack is loaded in the juicer. Accordingly, the information region of the juicer pack faces the reader 904 when the juicer pack is correctly loaded in the juicer. Such an arrangement may be appropriate for use with a reader and information region such as a QR code and associated optical or laser based reader.

Although a juice pack with an information region located on an exterior surface of the juicer pack is described above, it should be understood that other configurations may also be suitable. For example, an information region may include a component located within an interior of a juicer pack, such as an RFID tag located within laminated layers of the juicer pack, or a printed tag (e.g., a QR code) that is viewable through one or more transparent layers of the juicer pack. Accordingly, it should be understood that the current disclosure is not limited to any particular configuration for an information region on a juicer pack.

For the system of the present disclosure, the juice press also includes a control system that can control operations as described above. In addition, in some embodiments, the juicer includes a controller configured to control one or more aspects of the operation of the juicer. For example, a controller may include one or more circuits coupled to a drive mechanism and/or other active components of the juicer. For example, a control circuit may provide control signals such as a variable current to a motor of the drive mechanism to control the force applied by a displaceable platen used to squeeze the pack to produce juice. In this way, the platens press the chopped food matter contained in the juice pack to squeeze the juice from the food matter and the resulting juice flows from the pack and into a beverage container. Moreover, the control circuits of a juicer may control other juicer functions, such as operating a lock, operating a reader to read information stored in an information region of a juicer pack, receiving operator input (such as commands for juicer operation), outputting information (e.g., to a visible display screen, indicator lights, juicer status information in electronic data form, and so on), and other functions.

The control circuits include any suitable components to perform the desired control, communication, and/or other internet required functions required by the system of the present disclosure. For example, a control circuit may include one or more general purpose computers, a network of computers, one or more microprocessors, etc. for performing data processing functions, one or more memories for storing data and/or operating instructions (e.g., including volatile and/or non-volatile memories such as optical disks and disk drives, semiconductor memory, magnetic tape or disk memories, and so on), communication buses or other communication devices for wired or wireless communication (e.g., including various wires, switches, connectors, Ethernet communication devices, WLAN communication devices, and so on), software or other computer-executable instructions (e.g., including instructions for carrying out functions related to the present disclosure and/or controlling the load current control circuit as described above and other components), a power supply or other power source (such as a plug for mating with an electrical outlet, batteries, transformers, etc.), relays and/or other switching devices, mechanical linkages, one or more sensors or data input devices (such as a sensor to detect the position of the door of the juicer, a video camera or other imaging device to capture and analyze information regarding a juicer pack or other components, position sensors to indicate positions of a displaceable pressing surface, locking bolts, and so on), user data input devices (such as buttons, dials, knobs, a keyboard, a touch screen or other), information display devices (such as an LCD display, indicator lights, a printer, etc.), and/or other components for providing desired input/output and/or control functions.

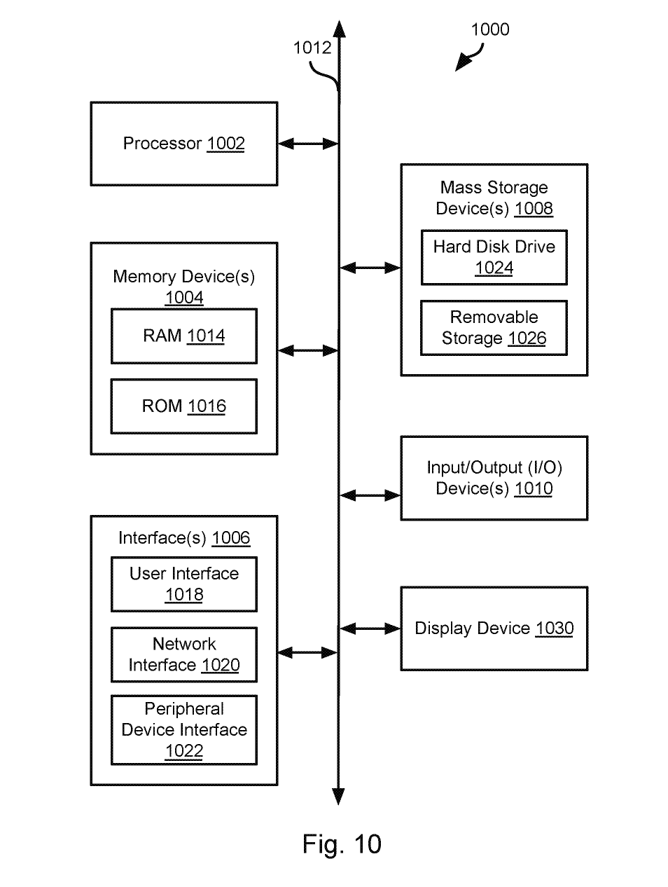

FIG. 10 is a block diagram illustrating an example computing device 1000. Computing device 1000 may be used to perform various procedures, such as those discussed herein. The servers, user computing devices, and controller for the juicer may have some or all of the attributes of the computing device 1000.

Computing device 1000 includes one or more processor(s) 1002, one or more memory device(s) 1004, one or more interface(s) 1006, one or more mass storage device(s) 1008, one or more input/output (I/O) device(s) 1010, and a display device 1030 all of which are coupled to a bus 1012. Processor(s) 1002 include one or more processors or controllers that execute instructions stored in memory device(s) 1004 and/or mass storage device(s) 1008. Processor(s) 1002 may also include various types of computer-readable media, such as cache memory.

Memory device(s) 1004 include various computer-readable media, such as volatile memory (e.g., random access memory (RAM) 1014) and/or nonvolatile memory (e.g., read-only memory (ROM) 1016). Memory device(s) 1004 may also include rewritable ROM, such as Flash memory.

Mass storage device(s) 1008 include various computer readable media, such as magnetic tapes, magnetic disks, optical disks, solid-state memory (e.g., Flash memory), and so forth. As shown in FIG. 10, a particular mass storage device is a hard disk drive 1024. Various drives may also be included in mass storage device(s) 1008 to enable reading from and/or writing to the various computer readable media. Mass storage device(s) 1008 include removable media 1026 and/or non-removable media.

I/O device(s) 1010 include various devices that allow data and/or other information to be input to or retrieved from computing device 1000. Example I/O device(s) 1010 include cursor control devices, keyboards, keypads, microphones, monitors or other display devices, speakers, printers, network interface cards, modems, lenses, CCDs or other image capture devices, and the like.

Display device 1030 includes any type of device capable of displaying information to one or more users of computing device 1000. Examples of display device 1030 include a monitor, display terminal, video projection device, and the like.

Interface(s) 1006 include various interfaces that allow computing device 1000 to interact with other systems, devices, or computing environments. Example interface(s) 1006 include any number of different network interfaces 1020, such as interfaces to local area networks (LANs), wide area networks (WANs), wireless networks, and the Internet. Other interface(s) include user interface 1018 and peripheral device interface 1022. The interface(s) 1006 may also include one or more peripheral interfaces such as interfaces for printers, pointing devices (mice, track pad, etc.), keyboards, and the like.

Bus 1012 allows processor(s) 1002, memory device(s) 1004, interface(s) 1006, mass storage device(s) 1008, I/O device(s) 1010, and display device 1030 to communicate with one another, as well as other devices or components coupled to bus 1012. Bus 1012 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1000, and are executed by processor(s) 1002. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A distributed system comprising:
a generator that is adapted to generate a unique identifier for at least one of a plurality of consumable items;
a database being adapted to map the unique identifier of the at least one of the plurality of consumable items to an identifier of the consumer;
a server system adapted to:
receive an indication that the at least one of the plurality of consumable items should not be consumed by the consumer; and
trigger an action responsive to the indication that the at least one of the plurality of consumable items should not be consumed;
a point-of-consumption system coupled to the communication network and database and adapted to deny access to the at least one of the plurality of consumable items responsive to receiving the indication that the at least one of the plurality of consumable items should not be consumed; and
a point-of-sale system adapted to conduct a transaction by a consumer of at least one of a plurality of consumable items.

2. The distributed system according to claim 1, wherein the point-of-consumption system comprises a scanning device adapted to scan the unique identifier associated with the at least one of the plurality of consumable items, and responsive to a lookup operation using the unique identifier, denies access to the at least one of the plurality of consumable items.

3. The distributed system according to claim 1, wherein the database is further configured to map a plurality of ingredients and their respective source information to the unique identifier of the at least one of the plurality of consumable items.

4. The distributed system according to claim 1, wherein the server system is further adapted to send an alert message directly to a computer system of the consumer, the alert message indicating that the at least one of the plurality of consumable items should not be consumed.

5. The distributed system according to claim 1, wherein the server system is further adapted to indicate, to a manufacturer, one or more consumers that purchased a plurality of identified items that should not be consumed.

6. The distributed system according to claim 1, wherein the server system is further configured to receive an indication that one or more ingredients included in the at least one of the plurality of consumable items should not be consumed.

7. The distributed system according to claim 6, wherein the server system is further adapted to determine a linking between at least one of the plurality of ingredients to an identified consumer of a particular consumable item of the plurality of consumable items that contains the at least one of the plurality of ingredients.

8. The distributed system according to claim 1, wherein the server system is further configured to determine, at a point after manufacture of at least one of the plurality of consumable items, that the at least one of the plurality of consumable items should not be consumed based on a determination that at least one of the one or more ingredients should not be consumed.

9. The distributed system according to claim 1, wherein the server system is further adapted to communicate an identification of that the at least one of the plurality of consumable items to a point-of-consumption system used to consume the at least one of the plurality of consumable items;

10. The distributed system according to claim 1, wherein the point-of-consumption system is adapted to record access to one or more of the plurality of consumable items in a database.

11. The distributed system according to claim 1, wherein the point-of-consumption system includes a juice press system; and
wherein the one or more consumable items include juice packs adapted to be processed using the juice press system.

12. A computer-implemented method comprising:
determining a mapping of customer information to a consumable item;
generating a unique identifier for each of a plurality of consumable items;
determining, at a point after manufacture of at least one of the plurality of consumable items, that the at least one of the plurality of consumable items should not be consumed; and
triggering, based on the act of determining that the at least one of the plurality of consumable items should not be consumed, an action in relation to the at least one consumable item by transmitting, to a point-of-consumption system, an indication that the at least one of the plurality of consumable items should not be consumed.

13. The method according to claim 12, further comprising an act of storing a mapping of information identifying one or more ingredients to the at least one of the plurality of consumable items;
wherein the information identifying one or more ingredients includes at least one of a group of information comprising:
source of the ingredient;
production date; and
production lot information.

14. The method according to claim 13, determining, at a point after manufacture of at least one of the plurality of consumable items, that the at least one of the plurality of consumable items should not be consumed based on a determination that at least one of the one or more ingredients should not be consumed.

15. The method according to claim 12, further comprising:
an act of conducting a purchase transaction of at least one of the plurality of consumable items at a point of sale by a consumer, and associating the unique identifier with an identifier of the consumer in a database;
an act of triggering, based on the act of determining that the at least one of the plurality of consumable items should not be consumed, an action in relation to the at least one consumable item using the consumer identifier stored in the database; and
wherein the act of conducting a purchase transaction of at least one of the plurality of consumable items at a point of sale by a consumer is performed online, and wherein the method further comprises shipping the at least one of the plurality of consumable items to the customer.

16. A point of consumption device comprising:
a food processing element;
a reader; and
a controller coupled to the food processing element and the reader, the controller programmed to:
receive, from the network device, an indication of items that should not be consumed;
scan a unique identifier on a product in the food processing element using the reader;
when the unique identifier corresponds to the indication of items that should not be consumed, refrain from operating the food processing element to process the product; and
when the unique identifier does not correspond to the indication of items that should not be consumed, cause the food processing element to process the product.

17. The point of consumption device of claim 16, wherein the food processing element is a press.

18. The point of consumption device of claim 13, wherein the product is a juice pack.

19. The point of consumption device of claim 13, wherein the controller is further programed to:
receive a list of identifiers prior to placement of the product in the food processing element;
store the list of identifiers; and
compare the unique identifier to the list of identifiers.

20. The point of consumption device of claim 13, wherein the controller is further programed to:
when the unique identifier corresponds to the indication of items that should not be consumed, transmit a notification to a mobile device of a user.
